(19) United States
(12) Patent Application Publication
(10) Pub. No.: US 2013/0268452 A1
(43) Pub. Date: Oct. 10, 2013

(54) METHODS AND APPARATUS FOR MATCHING BETWEEN EMPLOYERS AND EMPLOYEES

(71) Applicants: Bruce MacEwen, New York, NY (US); Janet Stanton, New York, NY (US); Andrew D. Martin, St. Louis, MO (US); Kevin M. Quinn, Oakland, CA (US)

(72) Inventors: Bruce MacEwen, New York, NY (US); Janet Stanton, New York, NY (US); Andrew D. Martin, St. Louis, MO (US); Kevin M. Quinn, Oakland, CA (US)

(21) Appl. No.: 13/443,478

(22) Filed: Apr. 10, 2012

(51) Int. Cl. G06Q 10/06

(52) U.S. Cl. 705/321

(57) ABSTRACT

A system, methods, and apparatus for matching employers to employees are disclosed. In an example embodiment, preferences submitted by employers and employees are stored. The preferences may include number of open positions, industry, location, salary, work experience, education level and background information received from employers and employees. The employers may be stably matched to employees in a many to many relationship. The resulting matches may be stable such that (i) no employee would prefer to be unmatched than stay with the employer matched with the employee, (ii) no employer would prefer to be unmatched than stay with the employees matched with the employer, and (iii) no employee and employer that are not matched with each other would prefer to match with each other rather than remain matched with their current matches. The matches may be employer-optimized or employee-optimized.

### BACKGROUND

Law firms hire law students through a recruitment process. Law firms typically begin with a pool of potential applicants, such as from resume submissions, or from brief on campus screening interviews, and then reduce the number of applicants to a smaller pool for further consideration. Law firms then select a number of the remaining students to meet in face-to-face interviews and extend offers to some of the interviewed students.

Students submit resumes to potential employers and attend some or all of the face-to-face interviews to which they are invited, and accept one offer from the law firm they deem to be most suitable. In many cases, the matches actually made between law firms and law students are not the best matches or the most effective matches. In particular, students and law firms see each other sequentially. Desirable students may receive many offers. Many law firms may make offers to the same student. Students are under pressure to stop the process and accept an acceptable offer. The end result is a process that consumes large amounts of resources, and may not produce particularly good matching between students and law firms.

### SUMMARY

The present disclosure provides a new and innovative system, method and apparatus for matching law firms to law students, or for use in other types of matching between employers and potential employees, or candidates for other types of potential placements.

In an example embodiment, a method of matching a set of potential employers and a set of potential employees using a computer is provided, comprising: receiving at the computer from each potential employer (Rᵢ) a first ranking of the potential employees; receiving at the computer from each potential employee a second ranking of the potential employers; receiving at the computer from each potential employer a value (Pᵢ) indicating a maximum quantity of matches the potential employer will accept; storing in the computer a value (Q) indicating a quantity of matches for the potential employees; and calculating with the computer a matching of the potential employers and potential employees that includes pairs of potential employers and potential employees, wherein, for at least some of the potential employees, the matching includes Q potential matches between the at least some potential employees and the potential employers, wherein Q is greater than 1, and wherein, for at least some of the potential employers, the matching includes Pᵢ matches between the at least some potential employers and the potential employees.

Additional features and advantages of the disclosed method and apparatus are described in, and will be apparent from, the following Detailed Description and the Figures.

### BRIEF DESCRIPTION OF THE FIGURES

FIG. 1 is a high level block diagram of an example network communicating system, according to an example embodiment of the present invention.

FIG. 2 is a detailed block diagram showing an example of a computing device, according to an example embodiment of the present invention.

FIG. 3 is a block diagram showing an example matching structure, according to an example embodiment of the present invention.

FIG. 4 is a flowchart illustrating an example process for matching employees to employers, according to an example embodiment of the present invention.

FIG. 5 is a flowchart illustrating an example process for matching employees to employers, according to an example embodiment of the present invention.

FIG. 6 is a flowchart illustrating an example process of a law firm using the employer-employee matching system, according to an example embodiment of the present invention.

FIG. 7 is a flowchart illustrating an example process of a law student using the employer-employee matching system, according to an example embodiment of the present invention.

FIG. 8 is a block diagram showing an example data architecture, according to an example embodiment of the present invention.

### DETAILED DESCRIPTION OF EXAMPLE EMBODIMENTS

The present disclosure relates in general to methods and systems for matching employers to employees, and in particular to providing matches between many employers and many employees. Briefly, in an example embodiment, a system is provided which allows a potential employer to specify the quantity of slots or positions they have available and rank the potential employees they would most like to hire, in order of preference. The system also allows employees to rank the employers they would most like to work for, in their order of preference. The system then compares the employers' preferences for employees with the employees' preferences for employers, giving both employers and employees their best chance of arranging a preferred hiring situation. In a non-limiting example embodiment, certain features disclosed in the present patent application may be commercially embodied in products and services offered by the assignee of the present application. It should be appreciated that the term “employee” as used herein may refer to potential employees or applicants, and that the term “employer” as used herein may refer to potential employers.

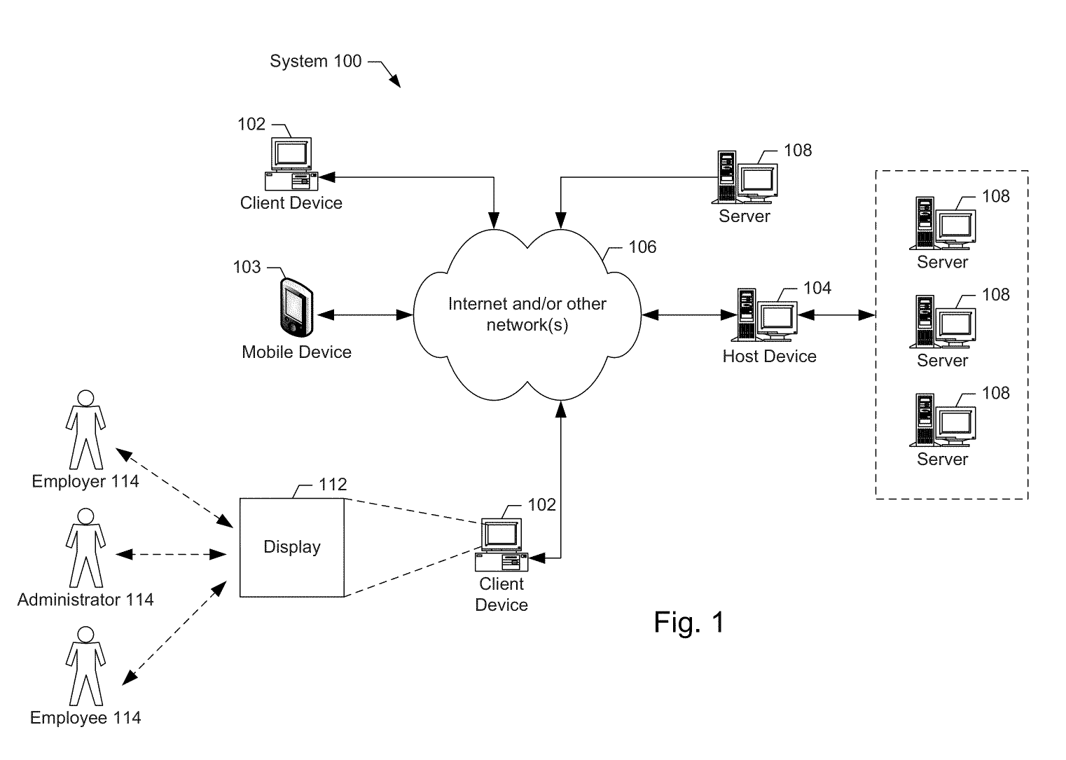

The present system may be readily realized in a network communications system. A high level block diagram of an example network communications system 100 is illustrated in FIG. 1. The illustrated system 100 includes one or more client devices 102, and one or more host devices 104. The system 100 may include a variety of client devices 102, such as desktop computers and the like, which typically include a display 112, which is a user display for providing information to users 114 of the employer-employee matching system, such as employers, administrators, and employees described below, and various interface elements as will be discussed in further detail below. A client device 102 may be a mobile device 103, which may be a cellular phone, a personal digital assistant, a laptop computer, a tablet computer, etc. The client devices 102 may communicate with the host device 104 via a connection to one or more communications channels 106 such as the Internet or some other data network, including, but not limited to, any suitable wide area network or local area network. It should be appreciated that any of the devices described herein may be directly connected to each other instead of over a network. Typically, one or more servers 108 may be part of the network communications system 100, and may communicate with host servers 104 and client devices 102.

One host device 104 may interact with a large number of users 114 at a plurality of different client devices 102. Accordingly, each host device 104 is typically a high end computer with a large storage capacity, one or more fast microprocessors, and one or more high speed network connections. Conversely, relative to a typical host device 104, each client device 102 typically includes less storage capacity, a single microprocessor, and a single network connection. It should be appreciated that a user 114 as described herein may include any person or entity which uses the presently disclosed system and may include a wide variety of parties. For example, as will be discussed in further detail below, users 114 of the presently disclosed system may include an employer, an employee and/or an administrator.

Typically, host devices 104 and servers 108 store one or more of a plurality of files, programs, databases, and/or web pages in one or more memories for use by the client devices 102, and/or other host devices 104 or servers 108. A host device 104 or server 108 may be configured according to its particular operating system, applications, memory, hardware, etc., and may provide various options for managing the execution of the programs and applications, as well as various administrative tasks. A host device 104 or server may interact via one or more networks with one or more other host devices 104 or servers 108, which may be operated independently. For example, host devices 104 and servers 108 operated by a separate and distinct entities may interact together according to some agreed upon protocol.

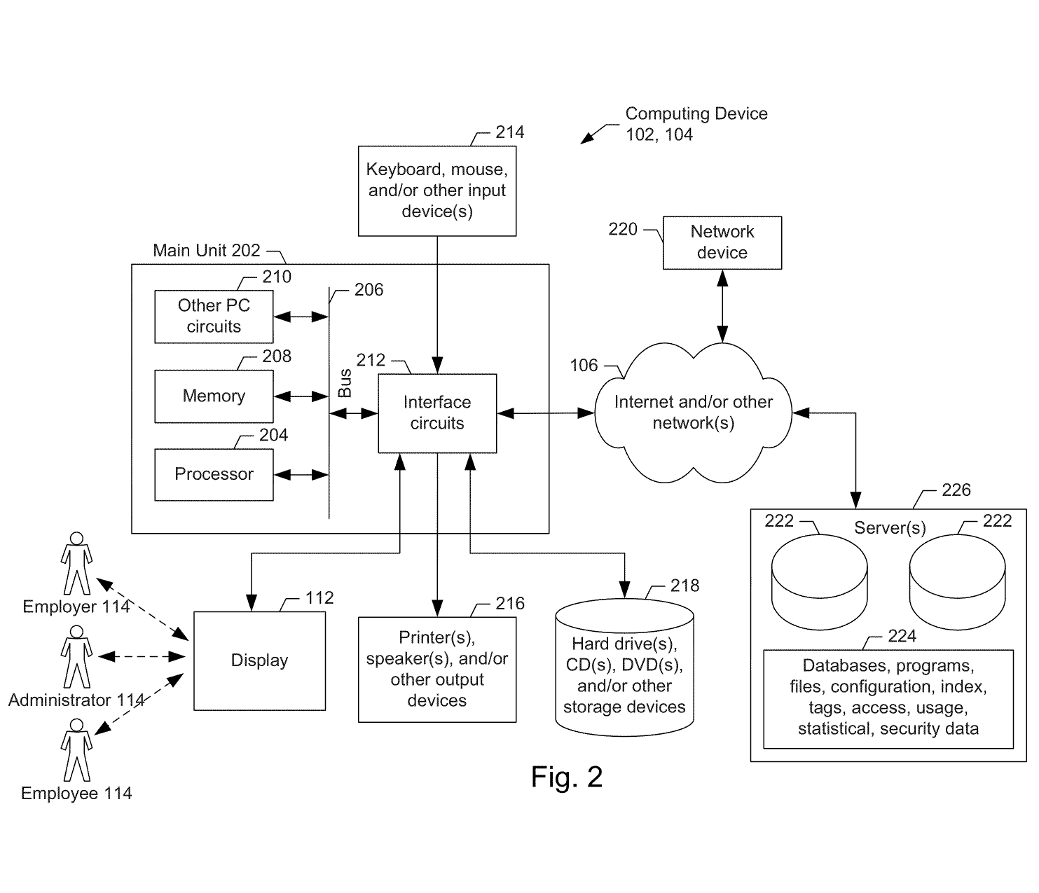

A detailed block diagram of the electrical systems of an example computing device (e.g., a client device 102, and a host device 104) is illustrated in FIG. 2. In this example, the computing device 102, 104 includes a main unit 202 which preferably includes one or more processors 204 electrically coupled by an address/data bus 206 to one or more memory devices 208, other computer circuitry 210, and one or more interface circuits 212. The processor 204 may be any suitable processor, such as a microprocessor from the INTEL PENTIUM® family of microprocessors. The memory 208 preferably includes volatile memory and non-volatile memory. Preferably, the memory 208 stores a software program that interacts with the other devices in the system 100 as described below. This program may be executed by the processor 204 in any suitable manner. In an example embodiment, memory 208 may be part of a “cloud” such that cloud computing may be utilized by a computing devices 102, 104. The memory 208 may also store digital data indicative of documents, files, programs, web pages, etc. retrieved from a computing device 102, 104 and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, image sensor, character recognition, barcode scanner, and/or a voice recognition system.

One or more displays 112, printers, speakers, and/or other output devices 216 may also be connected to the main unit 202 via the interface circuit 212. The display 112 may be a cathode ray tube (CRTs), a liquid crystal display (LCD), or any other type of display. The display 112 generates visual displays generated during operation of the computing device 102, 104. For example, the display 112 may provide a user interface, which will be described in further detail below, and may display one or more web pages received from a computing device 102, 104. A user interface may include prompts for human input from a user 114 including links, buttons, tabs, checkboxes, thumbnails, text fields, drop down boxes, etc., and may provide various outputs in response to the user inputs, such as text, still images, videos, audio, and animations. Users 114 of the employer-employee matching system may include employers, administrators, and employees described below.

One or more storage devices 218 may also be connected to the main unit 202 via the interface circuit 212. For example, a hard drive, CD drive, DVD drive, and/or other storage devices may be connected to the main unit 202. The storage devices 218 may store any type of data, such as pricing data, transaction data, operations data, inventory data, commission data, manufacturing data, image data, video data, audio data, tagging data, historical access or usage data, statistical data, security data, etc., which may be used by the computing device 102, 104.

The computing device 102, 104 may also exchange data with other network devices 220 via a connection to the network 106. Network devices 220 may include one or more servers 226, which may be used to store certain types of data, and particularly large volumes of data which may be stored in one or more data repository 222. A server 226 may include any kind of data 224 including databases, programs, files, libraries, pricing data, transaction data, operations data, inventory data, commission data, manufacturing data, configuration data, index or tagging data, historical access or usage data, statistical data, security data, etc. A server 226 may store and operate various applications relating to receiving, transmitting, processing, and storing the large volumes of data. It should be appreciated that various configurations of one or more servers 226 may be used to support and maintain the system 100. For example, servers 226 may be operated by various different entities, including automobile manufacturers, brokerage services, automobile information services, etc. Also, certain data may be stored in a client device 102 which is also stored on the server 226, either temporarily or permanently, for example in memory 208 or storage device 218. The network connection may be any type of network connection, such as an Ethernet connection, digital subscriber line (DSL), telephone line, coaxial cable, wireless connection, etc.

Access to a computing device 102, 104 can be controlled by appropriate security software or security measures. An individual users' 114 access can be defined by the computing device 102, 104 and limited to certain data and/or actions. Accordingly, users 114 of the system 100 may be required to register with one or more computing devices 102, 104. For example, registered users 114 may be able to request or manipulate data, such as submitting requests for pricing information or providing an offer or a bid.

As noted previously, various options for managing data located within the computing device 102, 104 and/or in a server 226 may be implemented. A management system may manage security of data and accomplish various tasks such as facilitating a data backup process. A management system may be implemented in a client 102, a host device 104, and a server 226. The management system may update, store, and back up data locally and/or remotely. A management system may remotely store data using any suitable method of data transmission, such as via the Internet and/or other networks 106.

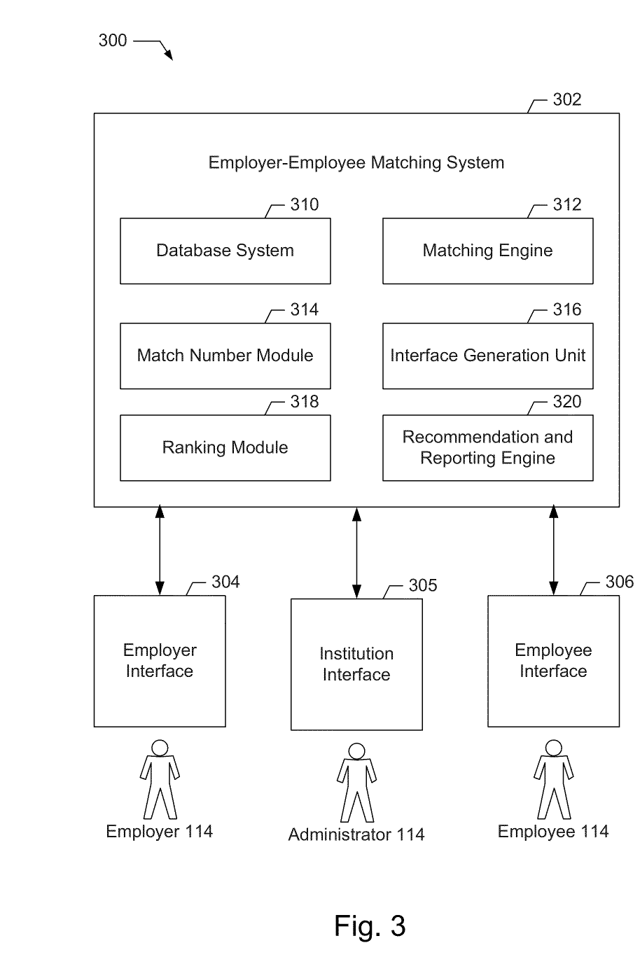

FIG. 3 is a block diagram showing an example matching structure 300 which includes an employer-employee matching system 302, an employer interface 304, an institution interface 305, and an employee interface 306. The example employer-employee matching system 302 may be implemented on one or more host devices 104 accessing one or more servers 108, 226. In an example embodiment, the employer-employee matching system 302 includes a database system 310, a matching engine 312, a match number module 314, an interface generation unit 316, a ranking module 318 and a recommendation and reporting engine 320. A user 114 may be, for example, an employer or an employee that interacts with the employer interface 304 or employee interface 306, respectively. A database system 310 may include a wide variety of data about employees and employers interested in being matched with employers and employees, respectively. A matching engine 312 may provide stable matches for employees and employers. A match number module 314 may be used to configure the quantity of matches provided to employees. In one example embodiment, the employer-employee matching system provides three matches to employees as a default setting. Interface generation unit 316 may provide, for example, HTML files that are used at the employer interface 304, institution interface 305, and employee interface 306 to provide information to the users 114. It should be appreciated that employer interface 304, institution interface 305, and employee interface 306 may be considered to be part of the employer-employee matching system 302, however, for discussion purposes, the employer interface 304, institution interface 305, and employee interface 306 may be referred to as separate from the employer-employee matching system 302.

For example, a user 114 may interact with an employer interface 304 to research and review employees. For example, an employer may be looking to fill five open positions with employees. Or, an employer with multiple offices may be looking to fill two open positions in one office and three open positions in another office. The employer can use employer interface 304 to research and rank employees. The employer may interact with the employee interface 304 by inputting information about the employer's preferences or ranking available employees. The employer interface 304 may use ranking module 318 to facilitate ranking of the employees. The employer interface 304 may provide a wide variety of questions or prompts to help the employer rank employees. The employer may also input information about available positions that the employer can fill. The employer may input information about total available positions without specifying offices, or may input information about available positions in specific offices.

In one example embodiment, the employer may search for employees by specifying characteristics desired in employees. The employer-employee matching system then generates a table of employees that meet the specified characteristics.

For example, a user 114 may interact with an employee interface 306 to research and review employers. For example, an employee may be looking for a new job and may wish to secure a job with one of the employers using the employer-employee matching system. The employee can use employee interface 306 to research and rank employers. The employee may interact with the employee interface 306 by inputting information about the employee's preferences or ranking available employers. The employee interface 306 may use ranking module 318 to facilitate ranking of the employers. The employee interface 306 may provide a wide variety of questions or prompts to help the employee rank employers. The employee may also input information about the employee's preferences. Employee preferences may include, for example, quantity of hours worked per week, salary, location, etc. In one embodiment, an employee may be categorized based on his or her preferences. For example, an attorney looking to be matched with a law firm or other employer may be categorized as a staff attorney, a contract attorney, or a legal process outsourcing (LPO) attorney based upon the attorney's preferences for quantity of hours worked or location.

In one example embodiment, the matching structure 300 may include an institution interface 305 for institutions that are involved with employees and employers or have a vested interest in matching employees and employers. For example, matching structure 300 may include an institution interface 305 for school administrators to also be involved in the matching process. Alternatively, the institution interface 305 may be used by a matching service provider that sells or offers services related to employer-employee matching. In one embodiment, directors at law firms may be users 114 that interact with employer-employee matching system using employer interface 304, law students may be users 114 that interact with employer-employee matching system using employee interface 306, and administrators at law schools or matching service providers may be users 114 that interact with employer-employee matching system using institution interface 305.

It should be appreciated that the employer-employee matching system may be unaffiliated with any law firm, law school, law student organization or legal association. The employer-employee matching system may thus be independent of any political pressure or outside forces that could otherwise undermine the efficiency and credibility of the resulting matches.

The matching engine 312 may process data sent by the employer interface 304 and the employee interface 306. The matching engine 312 may also rely on data from database system 310. The matching engine 312 may also process information collected by the match number module 314 and the ranking module 318 to prepare stable matches, described in further detail below.

The recommendation and reporting engine 320 may use the data collected from employer interface 304 and employee interface 306 to make recommendations to employers and employees, separate from the stable matches provided by the matching engine 312. For example, recommendation and reporting engine 320 may access the database system 310 and the inputs from the employer interface 304 and employee interface 306 to recommend employees to the employer that the employer may not have ranked. Recommendation and reporting engine 320 may also provide reports to employers, for example, about employers fared against competitors, such as how employers were ranked by students compared to their competitors. Students likewise may receive reports about how students fared against other students. Recommendation and reporting engine 320 may provide market information about the legal market, such as trends, hiring increase, market saturation, etc. The market information may be de-identified data that does not contain any information that can be used to identify users. Instead, the market information may contain aggregated de-identified data gathered from combining information about several, e.g., tens or hundreds or even thousands, of users.

In one example embodiment, recommendation and reporting engine 320 may provide information to employers about which employees ranked them highly, allowing both employers and employees to focus on their most promising opportunities.

It should be appreciated that the employer interface 304 and the employee interface 306 may look similar and have similar functionality, but have some portions that look different and behave differently for employees and employers. The employer interface 304, institution interface 305, and employee interface 306 may also provide options for purchasing memberships or registering with an ID and a password. Registered users—e.g., employers or employees—may have more access to information and more functions available than non-registered users. In one example embodiment, one integrated interface may provide access to employer interface 304, institution interface 305, and employee interface 306. For example, a service provider that facilitates matches between employers and employees may own a website that includes employer interface 304, institution interface 305, and employee interface 306.

Accordingly, employer interface 304, institution interface 305, and employee interface 306 may provide a wide range of information, for example, based on any searches or queries performed by a user 114.

It should be appreciated that certain functions described as performed, for example, at employer-employee matching system 302, may instead be performed locally at employer interface 304, institution interface 305, and employee interface 306. It should be appreciated that the employer interface 304, institution interface 305, and employee interface 306 may be implemented, for example, in a web browser using an HTML file received from the employer-employee matching system 302. In an example embodiment, employer interface 304, institution interface 305, and employee interface 306 may be located on a website, and may further be implemented as a secure website. Employees and employers may view match results on secure web pages, requiring a login ID and a password, that can only be accessed by authorized users. Also, employer interface 304, institution interface 305, and employee interface 306 may require a local application, for example, which a use may pay for to have access to, for example, information from the employer-employee matching system 302 such as results output by the matching engine 312.

In one example embodiment, an example employer-employee matching system attempts to match at least one employer from a set of potential employers R_{1 . . . n} to at least one employee from a set of potential employees Y_{1 . . . m}. In one example embodiment, R_{1 . . . n} represent branches or offices of one or multiple employers. For example, an employer may have multiple branches that are looking to hire new employees. Many employers, such as law firms, make hiring decisions at the branch level because each branch is in the best position to determine how many new hires it needs. The employer-employee matching system outputs matches where each match is a pair Rᵢ, Yⱼ of employers and employees, Yⱼ is one of Y_{1 . . . m} and Rᵢ is one of R_{1 . . . n}.

In one example embodiment, Pᵢ represents the quantity of positions, or matches, that employer Rᵢ would like to fill with employees or candidates. Thus, Pᵢ represents the maximum quantity of matches that the employer-employee matching system provides to employer Rᵢ. In one example embodiment, even though each employee Yⱼ can only accept one position, each employee Yⱼ can be part of more than one match. Qⱼ denotes the maximum quantity of matches that the employer-employee matching system provides to employee Yⱼ. In one example embodiment, all employees Y_{1 . . . m} are part of the same quantity of matches, i.e., Q₁, Q₂, . . . Qₘ are all equal. In an alternative embodiment, the quantity of times employees are matched is different for different employees, i.e., Q₁, Q₂, . . . Qₘ are not all equal. The total quantity of matches, i.e., pairs of employers and employees, output by the employer-employee matching system depends on, among other things, the preferences submitted by employers and employees and the maximum quantity of matches Pᵢ and Qⱼ in which employers and employees, respectively, can be placed.

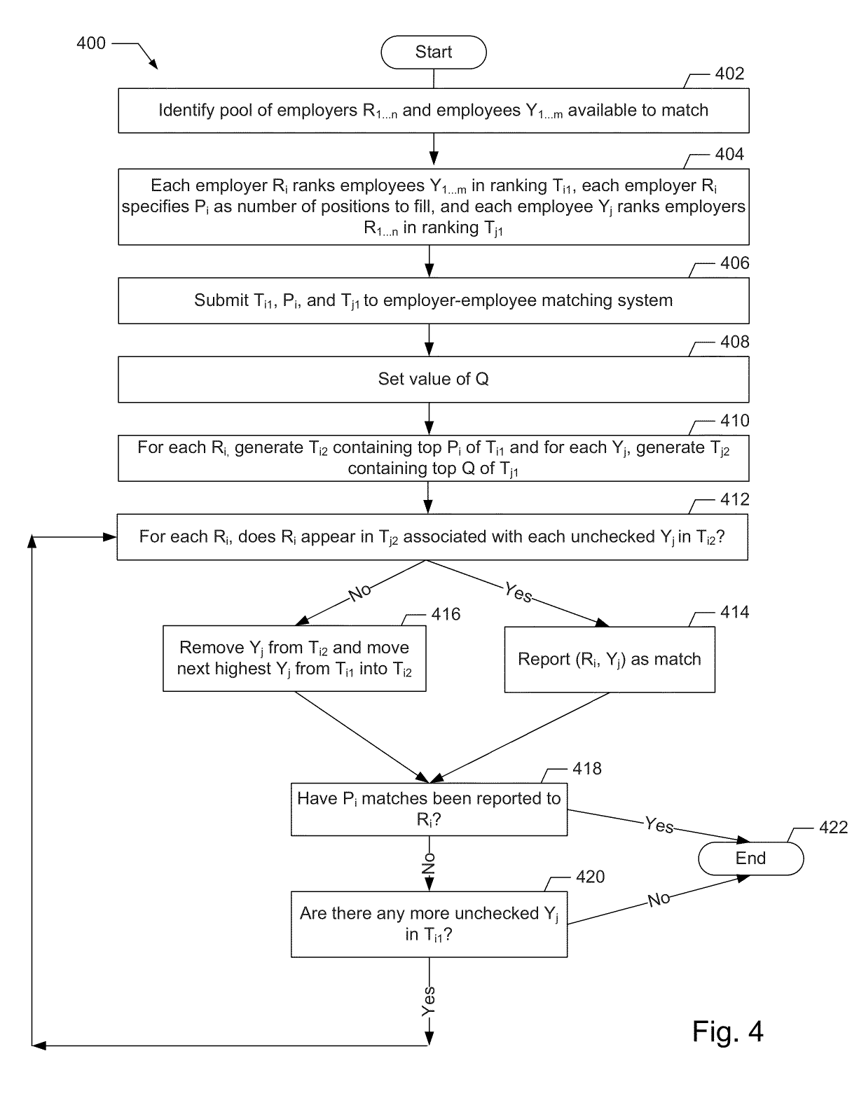

FIG. 4 is a flowchart of an example process 400 for matching employees to employers. Although the process 400 is described with reference to the flowchart illustrated in FIG. 4, it will be appreciated that many other methods of performing the acts associated with the process 400 may be used. For example, the order of many of the blocks may be changed, certain blocks may be combined with other blocks, and many of the blocks described are optional.

The example process 400 for matching employees to employers may allow employees to be efficiently and stably matched with employers. The example process 400 begins when employers R_{1 . . . n} and employees Y_{1 . . . m} are identified as available to match, as shown in block 402. Each employer Rᵢ ranks the employees Y_{1 . . . m} in a table Tᵢ₁ based upon information such as resumes, credentials, and work experience, as shown in block 404. For example, a law firm, a type of employer, may rank students, a type of employee, based upon the student's grades, coursework, experience, and law school. Each employer also specifies the number of open positions Pᵢ the employer is looking to fill, as shown in block 404. Each employee Yⱼ ranks the employers R_{1 . . . n} in a table Tⱼ₁, as shown in block 404, based upon information such as reputation, type of work the employer performs, and location. For example, students may rank law firms based upon information such as law firm reputation, salary, and type of work typically performed. Thus, each employer ranks employees based upon the employer's preferences, and each employee ranks employers based upon the employee's preferences. The values of Tᵢ₁, Pᵢ, and Tⱼ₁ are submitted to the employer-employee matching system, as shown in block 406.

Each employee can only fill one position, but the employer-employee matching system can provide multiple matches to employees. For example, the employer-employee matching system may attempt to provide up to three matches to some or all employees. The employer-employee matching system sets Q to the maximum quantity of matches the employer-employee matching system will provide to some or all employees, as shown in block 408. As discussed above, Q may be the same for all employees in one embodiment. In an alternative embodiment, Q may be different for some of the employees.

The employer-employee matching system analyzes each employer's preferences ranking and for each Rᵢ, generates a ranking Tᵢ₂ containing the top Pᵢ of Tᵢ₁, and for each Yⱼ, generates a ranking Tⱼ₂ containing the top Q of Tⱼ₁, as shown in block 410.

The employer-employee matching system then analyzes whether, for each Rᵢ, if Rᵢ appears in Tⱼ₂ associated with each Yⱼ in Tᵢ₂, as shown in block 412. In other words, the employer-employee matching system analyzes whether a mutual match appears between Tᵢ₂ for each employer Rᵢ and Tⱼ₂ for each employee Yⱼ in T,₂. Explained another way, the employer-employee matching system analyzes whether there is a match between an employer and employee such that the employer has ranked the employee in that employer's top Pᵢ and the employee has ranked the employer in that employee's top Q.

If the answer in block 412 is yes, then the pair of matching employer and employee is reported by employer-employee matching system, as shown in block 414. If the answer in block 412 is no, then the employer's ranking of top PᵢTᵢ₂—is modified by removing the employee that was just checked in block 412 and adding the next-highest ranked employee from Tᵢ₁, as shown in block 416. The employer-employee matching system continues comparing each employer's top Pᵢ with the top Q of each employee in that top Pᵢ until Pᵢ matches have been reported to the employer or there are no unchecked employees in Tᵢ₁ to check, as shown in blocks 418 and 420. When either Pᵢ matches have been reported to an employer Rᵢ or there are no unchecked employees to check, the process terminates. The employer-employee matching system follows the process of FIG. 4 for each employer until matching has been attempted for all employers.

In one embodiment, employers may update their preferences after the employer-employee matching system reports Pᵢ pairs to an employer or there are no more unchecked employees to check. If an employer updates its preferences, the employer-employee matching system runs through blocks 402 through 420, as needed, of FIG. 4. In one embodiment, process 400 may include several rounds of matches, where each round of matching is followed by an updating of employer preferences, employee preferences, the maximum number of open positions for an employer, or the maximum number of matches provided to an employee.

The resulting matches are stable such that (i) no employee would prefer to be unmatched, rather than stay with the employer matched with the employee, (ii) no employer would prefer to be unmatched, rather than stay with the employees matched with the employer, and (iii) no employee and employer pair that are not matched with each other would prefer to match with each other rather than remain matched with their current matches.

In example process 400, the employer-employee matching system cycles through each employer's rankings of most preferred employees, as shown in block 410. Cycling through each employer's rankings of most preferred employees results in employer-optimal matches because all employers prefer the matches that result from example process 400 to any other stable matches.

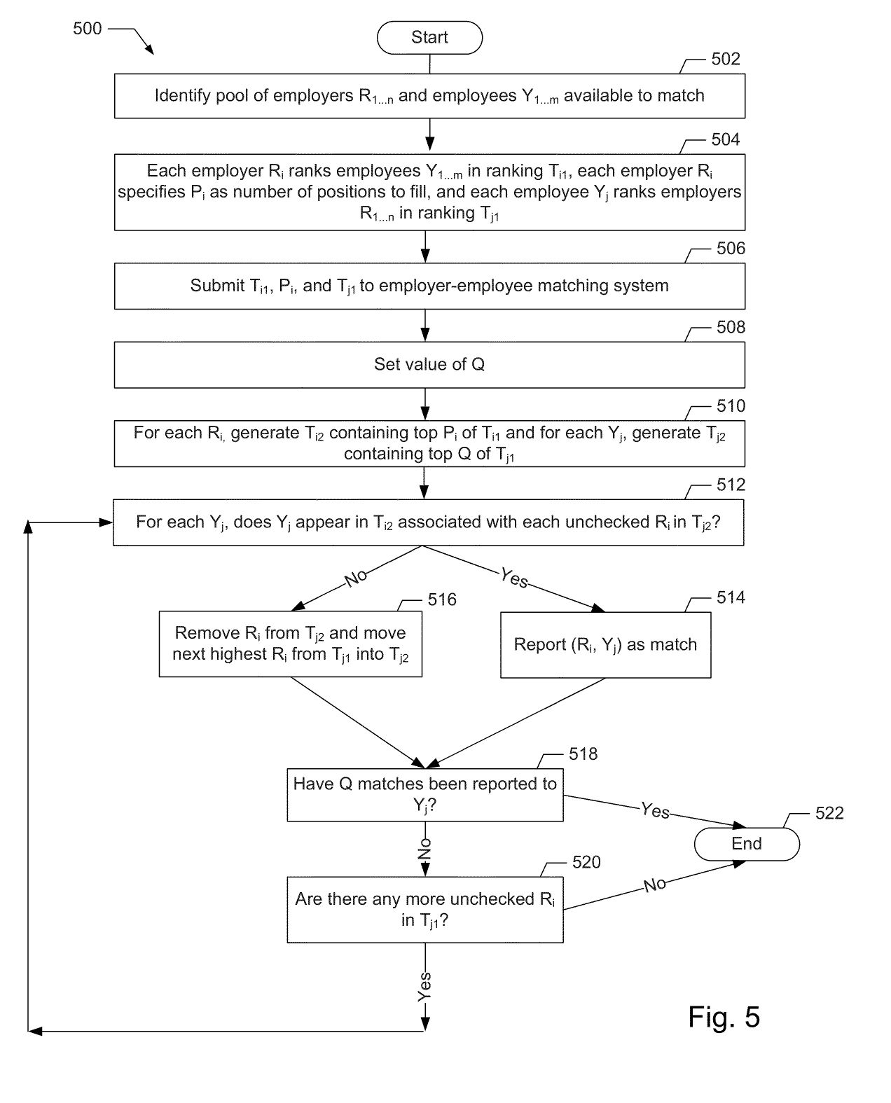

In one example embodiment, the employer-employee matching system may be employee-optimal. FIG. 5 is a flowchart of an example process 500 for matching employees to employers that produces employee-optimal matches. Although the process 500 is described with reference to the flowchart illustrated in FIG. 5, it will be appreciated that many other methods of performing the acts associated with the process 500 may be used. For example, the order of many of the blocks may be changed, certain blocks may be combined with other blocks, and many of the blocks described are optional.

The example process 500 begins when employers R_{1 . . . n} and employees Y_{1 . . . m} are identified as available to match, as shown in block 502. Each employer Rᵢ ranks the employees Y_{1 . . . m} in a table Tᵢ₁ based upon information such as resumes, credentials, and work experience, as shown in block 504. For example, a law firm, a type of employer, may rank students, a type of employee, based upon the student's grades, coursework, experience, and law school. Each employer also specifies the number of open positions Pᵢ the employer is looking to fill, as shown in block 504. Each employee Yⱼ ranks the employers R_{1 . . . n} in a table Tⱼ₁, as shown in block 504, based upon information such as reputation, type of work the employer performs, and location. For example, students may rank law firms based upon information such as law firm reputation, salary, and type of work typically performed. Thus, each employer ranks employees based upon the employer's preferences, and each employee ranks employers based upon the employee's preferences. The values o Tᵢ₁, Pᵢ, and Tⱼ₁ are submitted to the employer-employee matching system, as shown in block 506.

Each employee can only fill one position, but the employer-employee matching system can provide multiple matches to employees. For example, the employer-employee matching system may attempt to provide up to three matches to some or all employees. The employer-employee matching system sets Q to the maximum quantity of matches the employer-employee matching system will provide to some or all employees, as shown in block 508. As discussed above, Q may be the same for all employees in one embodiment. In an alternative embodiment, Q may be different for some of the employees.

The employer-employee matching system analyzes each employer's preferences ranking and for each Rᵢ, generates a ranking Tᵢ₂ containing the top Pᵢ of Tᵢ₁, and for each Yⱼ generates a ranking Tⱼ₂ containing the top Q of Tⱼ₁, as shown in block 510.

The employer-employee matching system then analyzes whether, for each Yⱼ, if Yⱼ appears in Tᵢ₂ associated with each Rᵢ in Tⱼ₂, as shown in block 512. In other words, the employer-employee matching system analyzes whether a mutual match appears between Tⱼ₂ for each employee Yⱼ in Tᵢ₂ and Tᵢ₂ for each employer Rᵢ. Explained another way, the employer-employee matching system analyzes whether there is a match between an employer and employee such that the employee has ranked the employer in that employee's top Q, and the employer has ranked the employee in that employer's top Pᵢ.

If the answer in block 512 is yes, then the pair of matching employer and employee is reported by employer-employee matching system, as shown in block 514. If the answer in block 512 is no, then the employee's ranking of top Q-Tⱼ₂—is modified by removing the employer that was just checked in block 512 and adding the next-highest ranked employer from Tⱼ₁, as shown in block 516. The employer-employee matching system continues comparing each employee's top Q with the top Pᵢ of each employer in that top Q until Q matches have been reported to the employee or there are no unchecked employers in Tⱼ₁ to check, as shown in blocks 518 and 520. When either Q matches have been reported to an employee or there are no unchecked employers to check, the process terminates. The employer-employee matching system follows the process of FIG. 5 for each employee until matching has been attempted for all employees.

In one embodiment, employees may update their preferences after the employer-employee matching system reports Q pairs to an employee or there are no more unchecked employers to check. If an employee updates its preferences, the employer-employee matching system runs through blocks 502 through 520, as needed, of FIG. 5. In one embodiment, process 500 may include several rounds of matches, where each round of matching is followed by an updating of employee preferences, employer preferences, the maximum number of open positions for an employer, or the maximum number of matches provided to an employee.

Again, the resulting matches are stable such that (i) no employee would prefer to be unmatched, rather than stay with the employer matched with the employee, (ii) no employer would prefer to be unmatched, rather than stay with the employees matched with the employer, and (iii) no employee and employer pair that are not matched with each other would prefer to match with each other rather than remain matched with their current matches.

In example process 500, the employer-employee matching system cycles through each employee's rankings of most preferred employers, as shown in block 506. Cycling through each employee's rankings of most preferred employers results in employee-optimal matches because all employees prefer the matches that result from example process 500 to any other stable matches.

Accordingly, if the employer-employee matching system cycles through employers' rankings of most preferred employees, the employer-employee matching system is employer-optimal. If the employer-employee matching system cycles through employees' rankings of most preferred employers, the employer-employee matching system is employee-optimal.

The example processes 400 and 500 thus stably match many employers to many students in an effective manner. Unlike many-to-many matches, many-to-one matches match many law firms with one student, or many students with one law firm. But many-to-many matches match many law firms to many students in one set of matches. For example, in one example embodiment, the employer-employee matching system may simultaneously match many law firms to many students.

In one example embodiment, the employer-employee matching system that produces many-to-many matches may require that the employees rank all employers only to fill one position, and not multiple positions in different slots or categories. For example, students looking to be matched with law firms are only interested in selecting one law firm at which to work full time. For example, no student may be looking to work as a corporate attorney at Firm A for twenty-five hours a week and also as a litigation attorney at Firm B for fifteen hours a week. Thus, the employer-employee matching system may not categorize the employers into types of employers.

In one example embodiment of the employer-employee matching system that produces many-to-many matches, employees may submit only one ranking at a time containing preferences about employers. For example, students may not submit one ranking for corporate attorney positions and another ranking for litigation attorney positions at the same time.

In one example embodiment of the employer-employee matching system that produces many-to-many matches, the employer-employee matching system may not require that all participating employers and employees will accept one of the matches. For example, the employer-employee matching system may match one student with three law firms. The employer-employee matching system does not require that the student select any one of the matched firms. Thus, the employer-employee matching system does not force the market to clear. Employers and employees utilizing the employer-employee matching system may not view the match results as being mandatory, i.e., they may elect to hire or work with an employee or employer outside of the match results. Instead, the employer-employee matching system promotes sharing information about best fits and presents efficient, stable matches but leaves much or all of the decision-making to the users.

In one example embodiment, the employer-employee matching system provides up to three matches to each employer. Alternatively, the employer-employee matching system may provide any quantity of matches, e.g., two, four, five, etc., to each employer. In one embodiment, the employer-employee matching system allows employers to make proposals to employees after employers receive matching results.

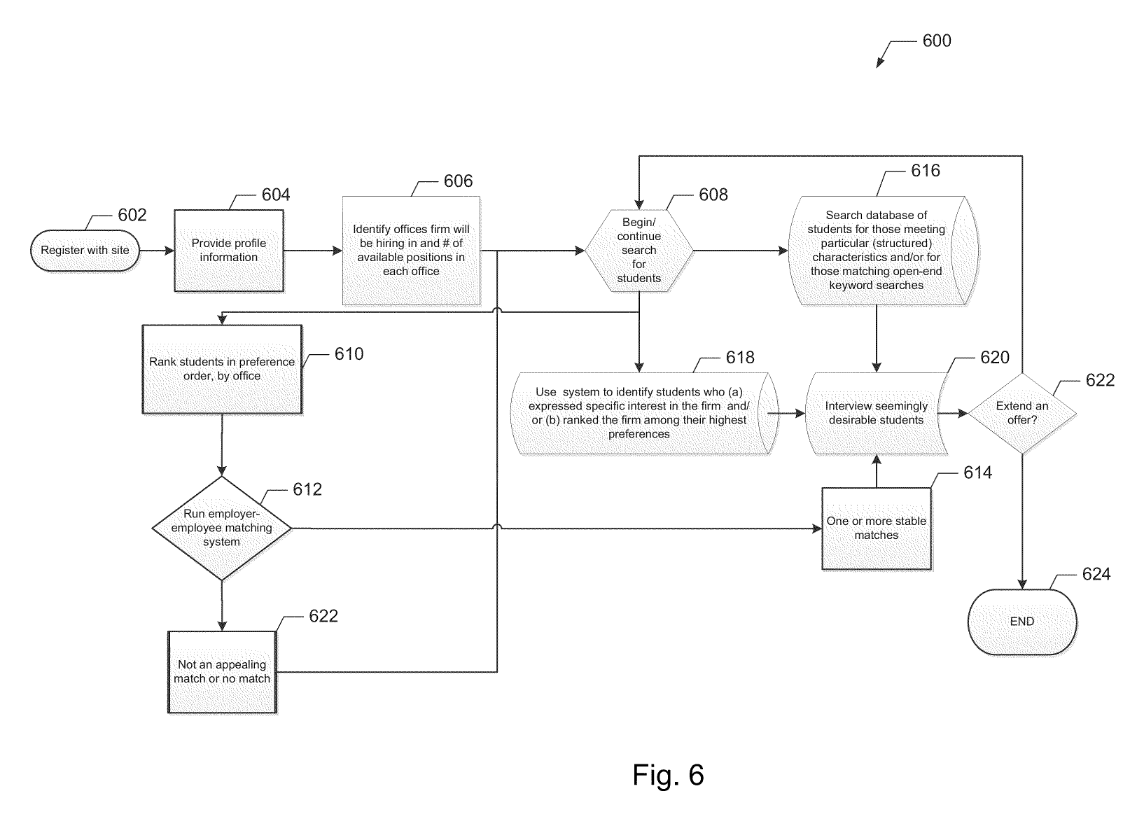

In one example embodiment, the employer-employee matching system is used to create stable matches between law firms and students. In one example embodiment, the employer-employee matching system is provided to law firms and students through a website. FIG. 6 illustrates an example process 600 of a law firm using the employer-employee matching system, according to one example embodiment of the present invention. As shown in block 602, example process begins when a law firm registers with a website that provides the employer-employee matching system. The law firm provides profile information, as shown in block 604. The law firm may have multiple offices. The law firm identifies the offices in which the firm will be hiring, and the quantity of available positions in each office, as shown in block 606. The law firm begins to search for students in a variety of ways (block 608). For each office with available positions, the law firm ranks students in preference order, as shown in block 610. The website runs the employer-employee matching system, as shown in block 612. For example, the website may be connected to a database and a computer readable medium that stores processes 400 and 500 described above. The website runs processes 400 and/or 500 using the information provided by the law firms and available students. The employer-employee matching system provides one or more stable matches, as shown in block 614. Or, if there are no appealing matches or no matches at all, the law firm may update its preferences and begin a new search, or wait a time interval such that student preferences have changed and begin a new search, as shown in block 622.

In one example embodiment, the law firm may also search for students in other traditional ways to supplement the stable matches provided in block 614. For example, the law firm may not receive enough matches to fill open positions. As shown in block 616, the law firm may search databases for students meeting specific criteria, such as, for example, students who have passed the California bar or have a background in chemical engineering. Or, as shown in block 618, the law firm may review students' preferences and identify students who expressed specific interest in the law firm or ranked the firm highly. Or the law firm may choose to only pursue stable matches resulting from block 614.

Accordingly, it should be appreciated that in one example embodiment, the employer-employee matching system may not be a replacement for an existing recruitment system. The employer-employee matching system may be used as an enhancement to improve employee-employer matches.

The students resulting from blocks 614, 616, and 618 may be interviewed, as shown in block 620. The firm decides which students, if any, should receive an offer, as shown in block 622. The example process 600 ends at block 624.

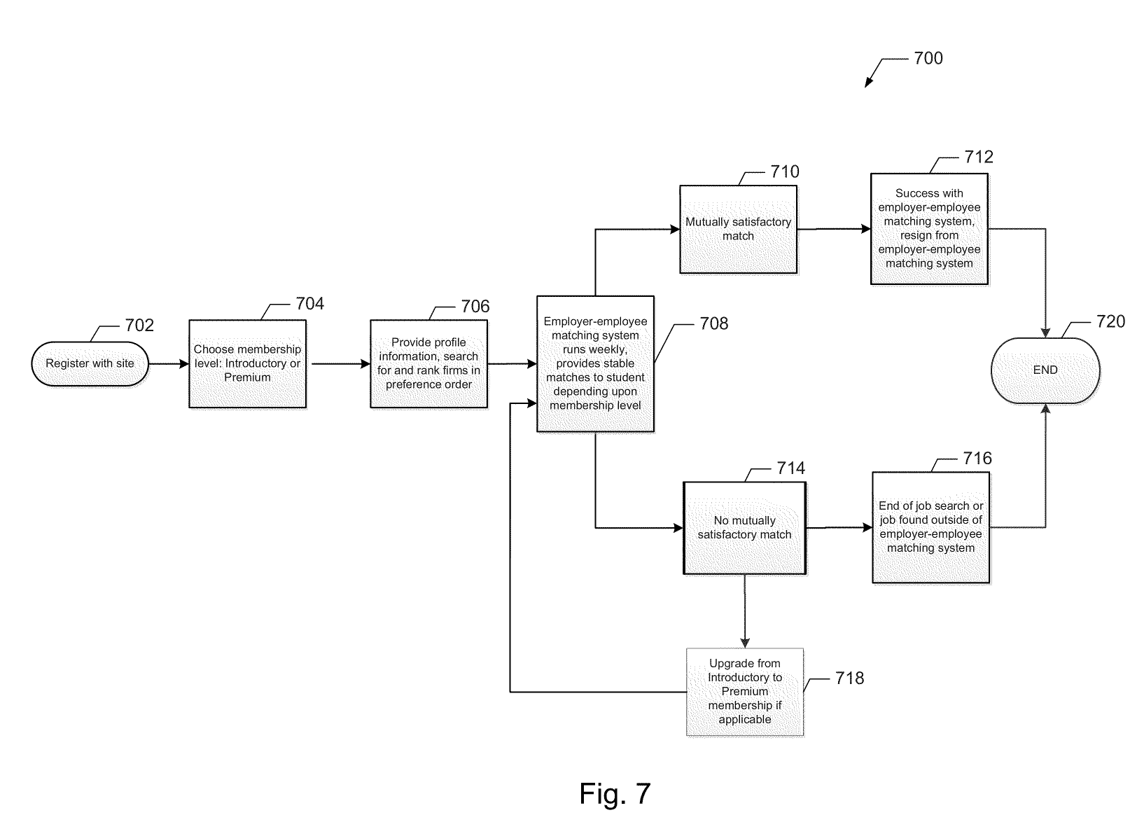

FIG. 7 illustrates an example process 700 of a law student using the employer-employee matching system, according to one example embodiment of the present invention. As shown in block 702, example process begins when a student registers with a website that provides the employer-employee matching system. The student is prompted to choose a membership level, such as for example, an Introductory membership level or a Premium membership level, as shown in block 704.

The student provides profile information and searches for and ranks law firms in preference order, as shown in block 706. The employer-employee matching system runs on a periodic basis, e.g., weekly. For example, the website may be connected to a database and a computer readable medium that stores processes 400 and 500 described above. The website runs processes 400 and/or 500 using the information provided by the student and available law firms. The employer-employee matching system provides one or more stable matches, as shown in block 708. If the student selected the Introductory membership level in block 704, the employer-employee matching system provides one match to the student. If the student selected the Premium membership level in block 704, the employer-employee matching system provides multiple matches, e.g., three, to the student. If the matches provided are mutually satisfactory to the student and the matched law firms, as shown in block 710, the student has successfully used the employer-employee matching system and resigns from the employer-employee matching system, as shown in block 712. If no mutually satisfactory match is made, as shown in block 714, the student may end his or her job search or find a job outside of the employer-employee matching system, as shown in block 716. Or, if no mutually satisfactory match is made, and if the student has selected the Introductory membership level in block 704, then the student may upgrade membership level to the Premium membership level, as shown in block 718. For example, the student may decide that he or she would like to see more matches than provided in the Introductory membership level. After the student changes membership level, the employer-employee matching system again provides one or more stable matches, as shown in block 708. The example process 700 ends at block 720 after the student has either successfully found a stable match, as shown in block 712, or if the student ends his or her job search or finds a job outside of the employer-employee matching system, as shown in block 716.

In one example embodiment, the employer-employee matching system may run the recommendation and reporting engine 320 after running the matching engine 312 stable matches have been provided. For example, employer-employee matching system may analyze the profiles of students each firm has identified as preferred and generates a composite profile of a preferred student. The employer-employee matching system may search the students participating in the employer-employee matching system to find other students closely resembling the composite profile of a preferred student.

Similarly, employer-employee matching system may analyze the profiles of firms each student has identified as preferred and generates a composite profile of a preferred firm. The employer-employee matching system then searches the firms participating in the employer-employee matching system to find other firms closely resembling the composite profile of a preferred firm.

It should be appreciated that the composite profiles of firms and/or students allows firms and students to consider students and firms, respectively, that they may not have otherwise ranked or considered. For example, an unmatched employee may still be discovered by an employer because the employee fits the characteristics of the composite profile of a preferred employee.

In one example embodiment, the employer may have open positions that remain unfulfilled even after matching engine 312 has completed providing stable matches. The employer can then fill the open positions with recommendations provided by recommendation and reporting engine 320.

In one example embodiment, the employer-employee matching system provides results in real-time. For example, if an employee changes his or her preferences relating to employers, the employer-employee matching system may automatically provide an updated match list based upon the modified preferences.

It should be appreciated that employer-employee matching system reduces the likelihood of a mismatch between employers and employees by delivering real-time market information that allows employees and employers to more accurately assess their marketability and adjust their expectations accordingly.

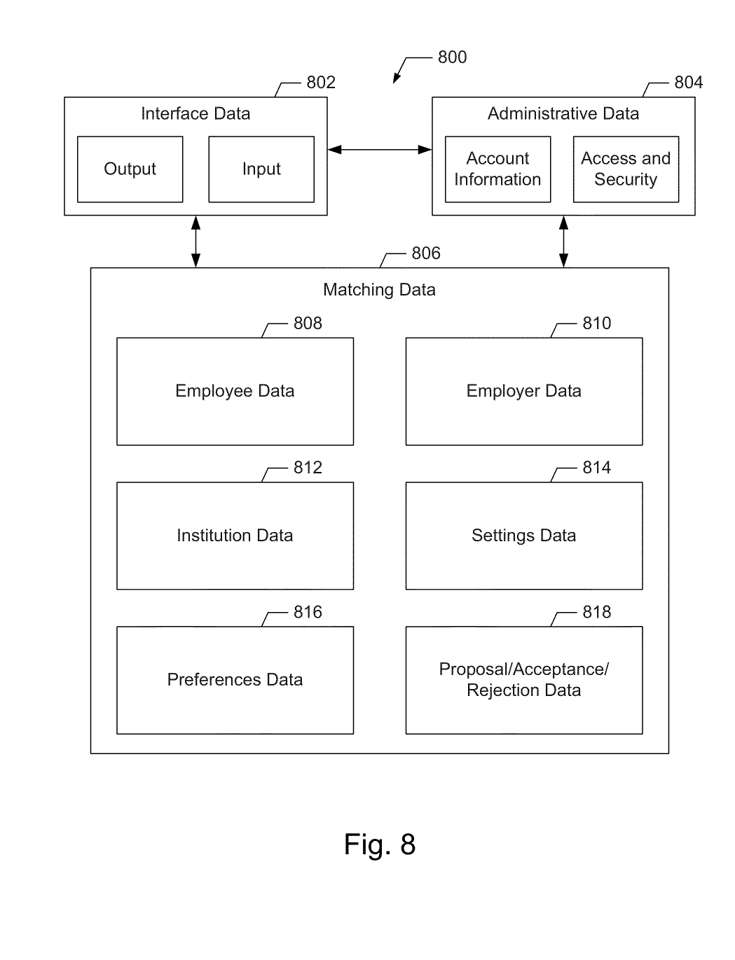

FIG. 8 illustrates a block diagram of an example data architecture 800. In the example data architecture 800, interface data 802, administrative data 804, and matching data 806 interact with each other, for example, based on user commands or requests. The interface data 802, administrative data 804, and matching data 806 may be stored on any suitable storage medium (e.g., server 226). It should be appreciated that different types of data may use different data formats, storage mechanisms, etc. Further, various applications may be associated with processing interface data 802, administrative data 804, and matching data 806. Various other or different types of data may be included in the example data architecture 800.

Interface data 802 may include input and output data of various kinds. For example, input data may include mouse click data, scrolling data, hover data, keyboard data, touch screen data, voice recognition data, etc., while output data may include image data, text data, video data, audio data, etc. Interface data 802 may include formatting, user interface options, links or access to other websites or applications, and the like. Interface data 802 may include applications used to provide or monitor interface activities and handle input and output data.

Administrative data 804 may include data and applications regarding account information and access and security. For example, administrative data 804 may include information used for as creating or modifying employee accounts or employer accounts. Further, administrative data 804 may include access data and/or security data. Administrative data 804 may interact with interface data 802 in various manners, providing a user interface 304, 305, 306 with administrative features, such as implementing a user login, password, and the like.

Matching data 806 may include, for example, employee data 808, employer data 810, institution data 812, settings data 814, preferences data 816, and/or proposal/acceptance/rejection data 818. Employee data 808 may include information about potential employees, such as name, age, education, work experiences, etc. Employer data 810 may include information about potential employers, such as name, industry, quantity of offices, average salaries, etc. Institution data 812 may include information about institutions involved with employees and employers, such as institution name, members, location, affiliations, etc. Settings data 814 may include information about the settings for an employer-employee matching system, such as the quantity of matches provided to each employee, how often to run the employer-employee matching system, etc. Preferences data 816 may include information about the preferences submitted by employees and employers. Proposal/acceptance/rejection data 818 may include information about proposals made, proposals accepted, and proposals rejected by either employees or employers.

It should be appreciated that data may fall under multiple categories of matching data 806, or change with the passage of time or circumstance. It should also be appreciated that matching data 806 may be tailored for a group of employees and employers, for example, if a new employer joins the employer-employee matching system as a potential employer, the employer data 810, institution data 812, settings data 814, preferences data 816, and proposal/acceptance/rejection data 818 may change.

The integration of the various types of matching data 806 received from the employer interface 304, institution interface 305, and employee interface 306 may provide a synergistic and optimal resource for employers, employees and institutions alike. In an example embodiment, a law student may benefit greatly from using an application in a mobile device 103 to receive both information about whether he or she matched with a law firm, in real-time, based upon registering with and subscribing to a service website implementing the employer-employee matching system.

Matching data 806 may be maintained in various servers 108, in databases or other files. It should be appreciated that, for example, a host device 104 may manipulate matching data 806 in accordance with the administrative data 804 and interface data 802 to provide requests or reports to users 114 including employers, employees and institutions, and perform other associated tasks.

In one example embodiment, the preferences used in and the results of the employer-employee matching system are displayed in a tabular format. Tables 1 to 4 illustrate information in tabular format about twenty-five law firms and one-hundred law students, for example, using an example employer-employee matching system to create stable firm-student matches.

Table 1 illustrates an example table of information input into database system 310 via employer interface 304 by twenty-five law firms fb1 to fb25 interested in being matched with one or more of students s1 to s100.

TABLE 1

| Firm Rankings of Students | Firm Quotas |
|---|---|
| fb1: [s79, s100, s68, s28, s13, s39, s78, s92] | fb1: 3 |
| fb2: [s70, s78, s50] | fb2: 1 |
| fb3: [s41, s77, s59, s44, s82] | fb3: 3 |
| fb4: [s75, s63, s98, s84, s67, s48, s47, s74] | fb4: 3 |
| fb5: [s50, s32, s72, s39, s70, s93, s69] | fb5: 2 |
| fb6: [s41, s50, s100, s46, s64, s13, s25, s36, s67] | fb6: 3 |
| fb7: [s72, s10, s79, s38, s76, s68, s23, s46] | fb7: 4 |
| fb8: [s40, s59, s44, s78, s14, s13, s21] | fb8: 4 |
| fb9: [s97, s25, s40, s58, s72] | fb9: 3 |
| fb10: [s25, s13, s96, s50, s59] | fb10: 4 |
| fb11: [s16, s10, s81, s23, s42] | fb11: 4 |
| fb12: [s98, s79, s68, s66, s32, s94] | fb12: 8 |
| fb13: [s39, s15, s17, s100, s38, s70, s25] | fb13: 4 |
| fb14: [s17, s73, s74, s51, s75, s8, s72, s86, s71] | fb14: 3 |
| fb15: [s50, s15, s78, s93, s31, s45, s96, s38, s99, s85, s53, | fb15: 5 |
| s90, s67] | |
| fb16: [s33, s77, s13, s28, s10, s79] | fb16: 8 |
| fb17: [s14, s79] | fb17: 5 |
| fb18: [s50, s86, s31, s36, s15, s47, s13, s35] | fb18: 3 |
| fb19: [s46, s34, s55, s80, s29, s15] | fb19: 4 |
| fb20: [s58, s95, s45, s49, s72, s86, s39, s51] | fb20: 3 |
| fb21: [s52, s96, s100, s25, s74, s17, s79] | fb21: 7 |
| fb22: [s8, s50, s75, s22, s70, s49, s34, s29, s18, s45, s20, | fb22: 8 |
| s61] | |
| fb23: [s49, s38, s1, s15, s85, s82, s77, s41, s12] | fb23: 5 |
| fb24: [s8, s37, s40, s79, s74, s73, s85] | fb24: 5 |
| fb25: [s60, s8, s16, s54, s29, s73] | fb25: 3 |

For example, firm branch fb1 ranks eight students in the following order: s79, s100, s68, s28, s13, s39, s78, and s92. Firm branch fb1 also selects three as the quota for the quantity of positions that fb1 is looking to fill.

Table 2 illustrates an example table of information input into database system 310 via employee interface 306 by one-hundred students s1 to s100 interested in being matched with one of law firms fb1 to fb25.

TABLE 2
Student Rankings of Firms

s1: [fb4, fb13, fb21, fb17, fb7, fb3, fb5, fb18, fb24, fb16, fb15, fb25,
fb8, fb14, fb9, fb12, fb1]
s2: [fb22, fb5, fb17, fb12, fb13, fb8, fb16, fb1, fb21, fb24, fb4, fb20,
fb3, fb7]
s3: [fb13, fb22, fb11, fb1, fb16, fb14, fb21, fb17, fb9, fb18, fb5, fb24,
fb2, fb8, fb7, fb15, fb3, fb20]
s4: [fb19, fb24, fb20, fb7, fb16, fb11, fb8, fb25, fb12, fb9, fb22, fb2,
fb10, fb17, fb13]
s5: [fb1, fb21, fb13, fb17, fb12, fb8, fb7, fb16, fb9, fb5, fb22, fb14,
fb11, fb4]
s6: [fb7, fb6, fb8, fb9, fb18, fb24, fb12, fb16, fb21, fb22, fb3, fb13,
fb17, fb4, fb5, fb1, fb23, fb15]
s7: [fb4, fb24, fb1, fb11, fb5, fb16, fb25, fb14, fb8, fb6, fb10, fb13,
fb20, fb9, fb22, fb21, fb7]
s8: [fb1, fb7, fb17, fb4, fb13, fb12, fb5, fb21, fb24, fb14, fb8, fb18,
fb9, fb16, fb22, fb10, fb25, fb2, fb15, fb20, fb23]
s9: [fb16, fb5, fb17, fb12, fb13, fb15, fb8, fb3, fb20, fb9, fb23, fb4,
fb11]
s10: [fb1, fb21, fb20, fb24, fb13, fb15, fb5, fb14, fb9, fb7, fb11, fb2,
fb4, fb22, fb12, fb23]
.
.
.
s90: [fb4, fb8, fb16, fb18, fb9, fb10, fb5, fb20, fb7, fb12, fb21, fb13,
fb3, fb11, fb24, fb1, fb23, fb19, fb14, fb25, fb6]
s91: [fb19, fb4, fb7, fb23, fb12, fb9, fb14, fb21, fb13]
s92: [fb10, fb23, fb5, fb1, fb7, fb13, fb22, fb18, fb8, fb3, fb17]
s93: [fb13, fb14, fb4, fb5, fb16, fb9, fb12, fb3, fb1, fb8, fb17, fb24]
s94: [fb9, fb12, fb16, fb14, fb19, fb11, fb23, fb13, fb18, fb5, fb2, fb8,
fb17, fb4, fb7, fb3, fb10, fb1]
s95: [fb22, fb21, fb14, fb8, fb12, fb20, fb4, fb25, fb15, fb11, fb24, fb7,
fb1, fb2, fb16, fb9, fb13, fb10]
s96: [fb7, fb16, fb1, fb9, fb14, fb17, fb6, fb19, fb5, fb13, fb8, fb20,
fb21, fb24, fb4, fb10, fb23, fb3]
s97: [fb6, fb5, fb7, fb2, fb9, fb16, fb1, fb8, fb24, fb13, fb21, fb4, fb12,
fb11, fb25, fb10]
s98: [fb13, fb20, fb21, fb5, fb7, fb3, fb17, fb9, fb25, fb16, fb15, fb12,
fb1]
s99: [fb1, fb18, fb13, fb9, fb5, fb11, fb16, fb8, fb10, fb3, fb22, fb7]
s100: [fb8, fb21, fb9, fb1, fb12, fb16, fb11, fb13, fb24, fb10, fb5, fb20,
fb3, fb14, fb7, fb22, fb4, fb25, fb17]

For example, student s1 ranks seventeen firms in the following order: fb4, fb13, fb21, fb17, fb7, fb3, fb5, fb18, fb24, fb16, fb15, fb25, fb8, fb14, fb9, fb12, and fb1.

Table 3 illustrates some of the matches resulting from an example employer-employee matching system where students that are matched at all are matched to one firm. For example, Table 3 may be some of the matches resulting from a student using the Introductory membership level discussed above with respect to FIG. 7.

TABLE 3

| Student | Firm |
|---|---|
| s13 | fb6 |
| s14 | fb17 |
| s15 | fb13 |
| s16 | fb25 |
| s17 | fb13 |
| s18 | fb22 |
| s21 | fb8 |
| s23 | fb7 |
| s25 | fb9 |
| s28 | fb16 |
| s29 | fb19 |
| s32 | fb5 |
| s33 | fb16 |
| s34 | fb22 |
| s36 | fb6 |
| s37 | fb24 |
| s38 | fb13 |
| s39 | fb13 |
| s40 | fb8 |
| s41 | fb3 |
| s42 | fb11 |
| s45 | fb20 |
| s46 | fb7 |

In one example embodiment, every student is not matched with a firm, and every firm is not matched with a student. Every firm does not receive a quantity of matches equal to that firm's quota of positions to fill. In the example matches illustrated in Table 3, the students that are matched are matched to only one firm. For example, student s 13 is matched with firm branch fb6. Firm fb6 may be matched with more than one student—e.g., students s13 and s36—up to the quantity of positions specified by fb6.

Table 4 illustrates some of the matches resulting from another example employer-employee matching system where students that are matched at all are matched to a maximum of three firms. For example, Table 4 may be some of the matches resulting from a student using the Premium membership level discussed above with respect to FIG. 7.

TABLE 4

| Student | Firm |
|---|---|
| s13 | fb6 |
| s13 | fb16 |
| s13 | fb18 |
| s14 | fb8 |
| s14 | fb17 |
| s15 | fb13 |
| s15 | fb23 |
| s16 | fb11 |
| s16 | fb25 |
| s17 | fb13 |
| s18 | fb22 |
| s23 | fb11 |
| s25 | fb9 |
| s25 | fb21 |
| s28 | fb1 |
| s28 | fb16 |
| s29 | fb6 |
| s32 | fb5 |
| s33 | fb16 |
| s34 | fb22 |
| s37 | fb24 |
| s38 | fb7 |
| s39 | fb13 |
| s40 | fb6 |
| s41 | fb3 |
| s45 | fb20 |

For example, student s13 is matched with firms fb6, fb16 and fb18. Student s14 is matched with firms fb8 and fb17. Some students may not receive any matches at all. Firm fb6 may be matched with more than one student—e.g., students s13, s29 and s40—up to the quantity of open positions specified by fb6.

For exemplary purposes, the present disclosure discusses various examples relating to matching law students and law firms. However, it should be appreciated that the disclosed system, methods, and apparatus may be advantageously used in relation to various employees and employers in any industry or job field, including but not limited to, private sector jobs, public sector jobs, state or federal clerkships, judicial internships, non-profit organizations, pro bono organizations, etc. It should also be appreciated that the employer-employee matching system may be used in any situation involving candidates and positions, such as, for example, students vying for internships, college students applying to sororities and/or fraternities during rush week, contestants seeking to appear on game shows, etc.

It will be appreciated that all of the disclosed methods and procedures described herein can be implemented using one or more computer programs or components. These components may be provided as a series of computer instructions on any conventional computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods and procedures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A method of matching a set of potential employers and a set of potential employees using a computer, comprising:
receiving at the computer from each potential employer (Rᵢ) a first ranking of the potential employees and a value (Pᵢ) indicating a maximum quantity of matches the potential employer will accept;
receiving at the computer from each potential employee a second ranking of the potential employers;
storing in the computer a value (Q) indicating a maximum quantity of matches that will be provided to each of the potential employees;
for each potential employer, creating using the computer a third ranking, each third ranking including up to the highest Pᵢ-ranked potential employees from the first ranking of the potential employees associated with the potential employer;
for each potential employer, reporting with the computer a potential match between the potential employer and any potential employee in the third ranking associated with the potential employer that ranked the potential employer in the highest Q of the potential employee's second ranking;
for each potential employer, deleting any potential employee in the potential employer's third ranking that did not rank the potential employer in the highest Q of the potential employee's rankings of the potential employers;
adding the next highest ranked potential employee, if any, to the potential employer's third ranking until the third ranking contains Pᵢ potential employees;
repeating the reporting, deleting and adding until for each potential employer: (i) Pᵢ potential matches have been reported for the potential employer or (ii) all of the potential employees from the potential employer's first ranking have been either reported as potential matches or deleted from the potential employer's third ranking; and
reporting a matching of the potential employers and potential employees that includes pairs of potential employers and potential employees,
wherein, for at least some of the potential employees, the matching includes Q matches between the at least some potential employees and the potential employers, and wherein Q is greater than 2, and
wherein, for at least some of the potential employers, the matching includes Pᵢ matches between the at least some potential employers and the potential employees.

2. The method of claim 1 wherein the Pᵢ for different employers is different.

3. The method of claim 1 wherein, upon completion, the resulting matching is stable such that based on the preferences provided by the potential employers and employees (i) no potential employee would prefer to be unmatched than stay with any potential employer matched with the potential employee, (ii) no potential employer would prefer to be unmatched than stay with any potential employees matched with the potential employer, and (iii) no potential employee and potential employer that are not matched with each other would prefer to match with each other rather than remain matched with their current matches.

4. A method of matching a set of potential employers and a set of potential employees using a computer, comprising:
receiving at the computer from each potential employer (Rᵢ) a first ranking of the potential employees;
receiving at the computer from each potential employee a second ranking of the potential employers;
receiving at the computer from each potential employer a value (Pᵢ) indicating a maximum quantity of matches the potential employer will accept;
storing in the computer a value (Q) indicating a quantity of matches for the potential employees; and
calculating with the computer a matching of the potential employers and potential employees that includes pairs of potential employers and potential employees,
wherein, for at least some of the potential employees, the matching includes Q potential matches between the at least some potential employees and the potential employers, wherein Q is greater than 1, and
wherein, for at least some of the potential employers, the matching includes Pᵢ matches between the at least some potential employers and the potential employees.

5. The method of claim 4 wherein the Pᵢ for different employers is different.

6. The method of claim 4, wherein, for at least some of the potential employees, Q is greater than 2.

7. The method of claim 4, wherein, for all of the potential employees, Q is greater than 1.

8. (canceled)

9. The method of claim 4, wherein, for all of the potential employers, their respective Pᵢ is greater than 1.

10. The method of claim 4, wherein, upon completion, the resulting matching is stable such that (i) no potential employee would prefer to be unmatched than stay with any potential employer matched with the potential employee, (ii) no potential employer would prefer to be unmatched than stay with any potential employees matched with the potential employer, and (iii) no potential employee and potential employer that are not matched with each other would prefer to match with each other rather than remain matched with their current matches.

11. The method of claim 4, further comprising:
(a) for each potential employer, creating using the computer a third ranking, each third ranking including up to the highest Pᵢ ranked potential employees from the first ranking of the potential employees associated with the potential employer;
(b) after (a), for each potential employer, reporting with the computer a potential match between the potential employer and any potential employee in the third ranking associated with the potential employer that ranked the potential employer in the highest Q of the potential employee's second ranking;
(c) after (b), for each potential employer, deleting any employee in the potential employer's third ranking that did not rank the potential employer in the highest Q of the potential employee's rankings of the potential employers;
(d) after (c), adding the next highest ranked potential employee, if any, to the potential employer's third ranking until the third ranking contains Pᵢ potential employees; and
(e) after (d), repeating (b) through (d) until for each potential employer: (i) Pᵢ potential matches have been reported for the potential employer or (ii) all of the potential employees from the potential employer's first ranking have been either reported as potential matches or deleted from the potential employer's third ranking.

12. (canceled)

13. The method of claim 11, wherein the matching is employer-optimal such that all of the potential employers prefer the resulting stable matching to any other stable matches.

14. (canceled)

15. The method of claim 4, further comprising:
(a) for each potential employee, creating using the computer a fourth ranking, each fourth ranking including up to the highest Q ranked potential employers from the second ranking of the potential employers associated with the potential employee;
(b) after (a), for each potential employee, reporting with the computer a potential match between the potential employee and any potential employer in the fourth ranking associated with the potential employee that ranked the potential employee in the highest Pᵢ of the potential employer's first ranking;
(c) after (b), for each potential employee, deleting any employer in the potential employee's fourth ranking that did not rank the potential employee in the highest Pᵢ of the potential employer's rankings of the potential employees;
(d) after (c), adding the next highest ranked potential employer, if any, to the potential employee's fourth ranking until the fourth ranking contains Q potential employers; and
(e) after (d), repeating (b) through (d) until for each potential employee: (i) Q potential matches have been reported for the potential employee or (ii) all of the potential employers from the potential employee's second ranking have been either reported as potential matches or deleted from the potential employee's fourth ranking.

16. (canceled)

17. The method of claim 15, wherein the matching is employee-optimal such that all of the potential employees prefer the resulting stable matching to any other stable matches.

18. (canceled)

19. (canceled)

20. The method of claim 10, wherein the employers are law firms and the employees are law students.

21. The method of claim 20, wherein the law students rank all the law firms only to fill one position at one office of one of the law firms, not multiple positions that are: (i) differentiated into categories, (ii) positions at more than one of the law firms, or (iii) positions at multiple offices of one of the law firms.

22. The method of claim 20, wherein the law students submit only one second ranking at a time containing preferences about the law firms.

23. (canceled)

24. (canceled)

25. The method of claim 20, wherein the stable matching is provided as part of a recruitment service.

26. The method of claim 25, wherein after providing the stable matching, the recruitment service provides recommendations of law firms and law students to law students and law firms, respectively, that are not currently matched with the law students and law firms in the stable matching.

27. The method of claim 25, wherein the law students can register with the recruitment service as an introductory member or a premium member.

28. The method of claim 27, wherein registering as a premium member causes Q to be greater than 2.

29. (canceled)

30. The method of claim 4, wherein Pᵢ represents a quantity of open positions.

31. A computing device for matching a set of potential employers and a set of potential employees using a computer, the computing device:
receiving at the computer from each potential employer (Rᵢ) a first ranking of the potential employees;
receiving at the computer from each potential employee a second ranking of the potential employers;
receiving at the computer from each potential employer a value (Pᵢ) indicating a maximum quantity of matches the potential employer will accept;
storing in the computer a value (Q) indicating a quantity of matches for the potential employees; and
calculating with the computer a matching of the potential employers and potential employees that includes pairs of potential employers and potential employees,
wherein, for at least some of the potential employees, the matching includes Q potential matches between the at least some potential employees and the potential employers, wherein Q is greater than 1, and
wherein, for at least some of the potential employers, the matching includes Pᵢ matches between the at least some potential employers and the potential employees.

32-57. (canceled)

58. A non-transitory computer readable medium storing software instructions for matching a set of potential employers and a set of potential employees which, when executed, cause an information processing apparatus to:
receive at the computer from each potential employer (Rᵢ) a first ranking of the potential employees;
receive at the computer from each potential employee a second ranking of the potential employers;
receive at the computer from each potential employer a value (Pᵢ) indicating a maximum quantity of matches the potential employer will accept;
store in the computer a value (Q) indicating a quantity of matches for the potential employees; and
calculate with the computer a matching of the potential employers and potential employees that includes pairs of potential employers and potential employees,
wherein, for at least some of the potential employees, the matching includes Q potential matches between the at least some potential employees and the potential employers, wherein Q is greater than 1, and
wherein, for at least some of the potential employers, the matching includes Pᵢ matches between the at least some potential employers and the potential employees.

59-84. (canceled)
